(19) United States
(12) Patent Application Publication
(10) Pub. No.: US 2009/0178759 A1
(43) Pub. Date: Jul. 16, 2009

(54) METHOD FOR JOINING ACRYLIC MATERIALS

(76) Inventor: Donald B. Provan, JR., Annapolis, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/354,712

(22) Filed: Jan. 15, 2009

Related U.S. Application Data
(60) Provisional application No. 61/011,110, filed on Jan. 15, 2008.

(51) Int. Cl. B29C 65/02; B27G 11/02

(52) U.S. Cl. 156/275.3; 156/379.8

(57) ABSTRACT

The present invention provides a method for joining acrylic materials. In the first step of the method a first and second pieces of acrylic material are selected. In a second step, a welding piece of the same acrylic material is selected. In a third step, the first and second pieces of acrylic material are prepared for welding. In the fourth step, the first and second pieces of acrylic material are welded utilizing the welding piece of the same acrylic material. The present invention also provides for a kit for practicing the method of joining acrylic materials and a method for welding an ornamental design to a piece of acrylic material.

### CROSS-REFERENCE TO RELATED APPLICATIONS

This application claims the benefit under 35 U.S.C. § 119(e) of U.S. Provisional Application No. 61/011,110 entitled “METHOD FOR JOINING ACRYLIC MATERIALS” filed on Jan. 15, 2008 which is hereby incorporated by reference in their entirety.

### BACKGROUND OF THE INVENTION

1. Field of the Invention

This invention generally relates to the field of materials science and more specifically to the construction of water resistant structures, such as surrounds for bathing areas (e.g., bath tubs and showers) and other water usage environments, for use in buildings wherein the materials forming the structural surround are employed to provide a water resistant bond.

2. Background

Shower stalls can be constructed in a number of different ways. Traditionally, the walls surrounding the shower are covered with ceramic tile. In order to install tile, a position rule is placed and leveled on the wall upon which tile is to be laid. The wall is then covered with tiling cement using a trowel. The tiles are placed on the wall and joining mortar is spread over the tiles, usually with a sponge. The excess mortar is whipped away and, once the joining mortar dries, the process is completed. Some methods allow the tiles to be installed without the need for a drying step.

In other bathrooms, acrylic materials are utilized to create the walls that form a shower enclosure. In some instances, the shower enclosure includes a bath tub or a hot tub and, in other instances, the walls extend to the floor. The materials utilized in creating this enclosures range from Acrylonitrile-Butadiene-Styrene (ABS) to Expandable Polystyrene (XPS). The walls are joined with each other and the floor, through the use of different caulking compounds and other soldering compounds. Such soldering compounds are referred to as flux in some instances. In many cases, these compounds are not aesthetically pleasing to the consumer and may not provide a lasting water resistant structure. Additionally they require some maintenance in order to prevent leaks that may lead to undesirable consequences such as mold and other inconvenient results for the user.

### SUMMARY OF THE INVENTION

The present invention provides a method for joining materials, preferably acrylic materials, in a manner that promotes the construction of a water resistant structure that further provides a significantly prolonged lifetime of water resistance to the structure. In a first aspect of the present invention, a method for joining two or more pieces of acrylic material includes selecting the pieces of acrylic material to be used from the group of acceptable materials; preparing the two or more pieces of acrylic material; selecting a welding piece of the same acrylic material; and for welding the two or more pieces of acrylic material.

In another aspect of the present invention, the step of preparing the two or more pieces of acrylic material for joining (or welding) is accomplished through a number of different methods such as sanding or chemical etching of the materials. The joining step is then accomplished through the use of a fusion welder or similar instrument that melts one of the pieces selected to be used as the joining or welding material.

In a further aspect of the present invention, the materials to be joined are used to create bathroom surrounds. The method of joining the acrylic materials is utilized to create a substantially water resistant enclosure(s). Another aspect of the present invention contemplates a system for joining acrylic materials comprising a welding apparatus, a welding material and an etching material.

In another aspect of the present invention, a kit for creating a substantially water resistant construct, such as a bathroom surround, is presented. In a contemplated preferred embodiment, the bathroom surround is a shower surround that includes three panels, a tub or shower floor, welding rods, a welding apparatus, and etching materials, wherein the panels, tub or shower floor, and rods are constructed from the same materials. The completed surround is substantially water resistant and is capable of remaining that way for a significantly prolonged period of time as compared to the current state of the art.

An additional aspect of the present invention includes installation of secondary structures on a substantially water resistant construct, such as the bathroom surround mentioned above; wherein the secondary structures may include a number of aesthetically designed forms or ornamental designs, such as dolphins, sport symbols, religious symbols and other constructs for placement on the bathroom surround. A further embodiment includes a method for attaching the secondary structures to one or more pieces of the substantially water resistant construct that includes the use of different adhesives or the method for joining acrylic compounds with the same materials from which they are constructed in accordance with the present invention. Other and additional objects of this invention will become apparent from a consideration of this entire specification.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a depiction of the method for joining ABS materials.

FIG. 2 describes the different areas of the materials to be joined.

FIG. 3 represents a bathroom surround created using the method of the present invention.

FIG. 4 describes the installation of secondary structures onto a bathroom surround.

### DETAILED DESCRIPTION

The invention summarized above may be better understood by referring to the following description, which should be read in conjunction with the accompanying drawings and claims. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In an effort to avoid the above-described disadvantages, a method for joining two pieces of plastic material is described in the present application. The method comprises preparing the materials to be joined and welding the materials with a fusion welder. The method may be utilized in a number of different applications, from creating waterproof bathroom enclosures, to siding, roofing and pluming constructs.

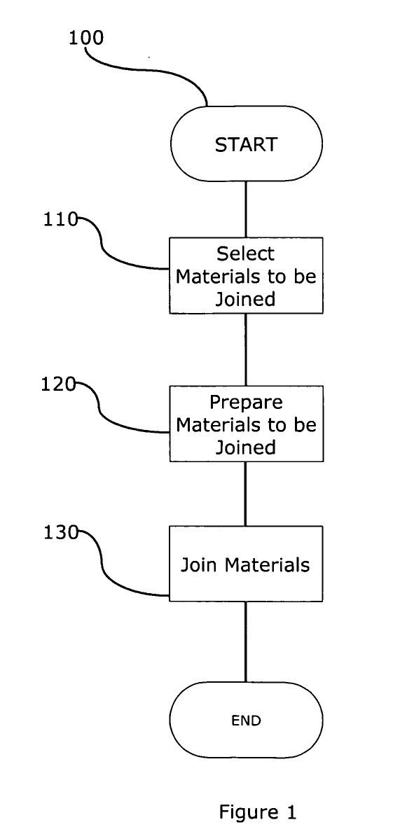

In a preferred embodiment shown in FIG. 1, a method 100 of joining two or more pieces of material through use of a third piece of similar material includes a first step 110 of selecting a material from which the at least three pieces are formed. In a second step 120, two or more pieces of the material selected in the first step 110 are prepared for joining. The prepared pieces are then joined together in a third step 130 (also referred to as the “welding step”), through the use of a welding apparatus or any other welding process understood by a skilled artisan in which a welding piece corresponds to one of the at least two or more pieces of material to be joined. Once the pieces are welded the welding material creates a joint that forms a substantially water resistant or water tight seal between the two or more pieces in a manner that may resist penetration by water or other liquids.

The two or more materials to be selected in the first step 110, may preferably be the acrylic, acrylo-lamitral butadiene/durable rubber (ABS/DR). It is contemplated that the two or more pieces to be joined may also be selected from various other materials, such as cellulose acetate (CA), cellulose acetate butolrate (CAB), poly-vinyl chloride (PVC), high density polyethylene (HDPE), high molecular weight polyethylene (HMW), ultrahigh molecular weight polyethylene (UHMVV), low density polyethylene (LDPE), linear low density polyethylene (LLDPE), ultra low density polyethylene (ULLDPE), medium density polyethylene (MDPE), high polypropylene (HPP), copolypropylene (CPP), thermo plastic urethane (TPU), polyethylene tirophylilate gluco-modified (PETG), acrylo-lamitral butadiene stylene (ABS), high impact poly styrene (HIPS), flexible PVC (FPVC), or acrylo-lamitral butadiene/durable rubber (ABS/DR).

In a second step 120, two or more pieces of selected material are prepared for joining. In one embodiment, the preparation of the two or more pieces may include the placement, which may or may not include affixing in the position/location of placement, of the two or more pieces in a location that establishes a desired physical proximity to one another that allows for the third step of the process, described below, to be performed. This physical locating may be promoted through the use of various tools and instruments and may be accomplished by employing various techniques and methodologies as are contemplated by skilled artisans.

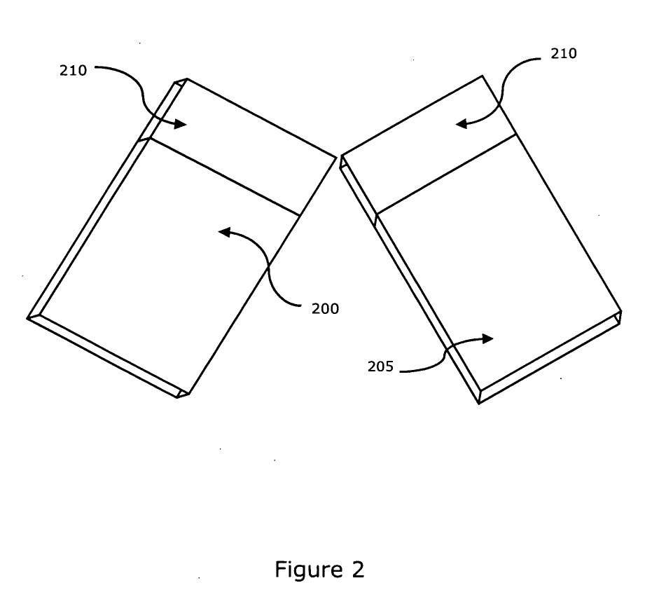

In the current embodiment of the method 100, the second step 120 of preparing the two or more pieces further includes the implementation of various piece and material manipulative processes, either mechanical or chemical, that occurs upon only a part or partial section of a surface area of each of the two or more pieces as shown in FIG. 2. The two or more pieces 200, also referred to as a first piece, and 205, also referred to as a second piece, include these parts and/or partial sections of surface area that are known as joining or welding areas 210. The welding areas 210 may be of various dimensional characteristics upon the surface area of the two or more pieces. It is further contemplated that the welding areas 210 may include various depth characteristics. For example, the manipulative process(es) employed may result in at least partial penetration into the material of the two or more pieces 200 and 205. The depth of that penetration may vary and may not necessarily be of consistent depth. The joining areas may abut one another when the two or more pieces 200 and 205 are joined or may be located in parts and/or partial sections of either piece that do not abut one another when the two or more pieces are joined. Thus, it is contemplated that the manipulative processes, mechanical or chemical, may be implemented upon each of the two or more pieces to be joined in various manners and locations.

It is contemplated that the manipulative processes employed may occur through manual application and/or manipulation or through an automated/automatic application. Forms of manipulation may include employing various processes, such as the sanding of the surface areas of the two or more pieces. The sanding process, which is the application of a mechanism, product and/or device to cause the scarring of the surface area of the material of the two or more pieces in a particular location (joining area), results in an etching of the two or more pieces in particular parts or sections of the pieces, otherwise known as the joining areas. The etching is a result of the breakdown of the material surface area by the sanding process and is observed to provide gouges and/or slashes in the surface of varying length, width and depth of penetration(s), to result in a non-smooth surface in the joining areas. The etching may promote the joining of these surface areas to one another, thereby promoting the joining of the two or more pieces.

In another example, a chemical process, that results in an etching of the two or more pieces similar to that described above, may be accomplished through the use of different priming materials. It is contemplated that various priming materials may be used to achieve the etching process and that the various priming materials, based on their different characteristic properties, such as different chemical makeup, may provide differences in the etching of the two or more pieces that are being joined. The priming material may be applied to the surface of the joining areas and allowed to set. The duration of time for which the priming material is allowed to set upon the joining areas of the two more pieces may vary depending on various factors. For example, certain material's chemical structure may require a longer period of time in order for a priming material to breakdown bonds and achieve an etching of the joining area. Alternatively, the caustic nature of the priming material may be the etch rate determining factor. Once etching is complete, excess priming materials may be removed if necessary. Removal of excess priming materials may be determined based upon the nature of the priming materials and their ability to continue to corrode the joining materials for an extended period of time.

After the two or more pieces joining areas 210 are etched, it is contemplated that the joining areas may be at least partially heated. This heating may occur through the use of various tools and processes, such as through use of a fusion welder or fusion apparatus. This heating of the joining areas may not result in the joining of the two or more pieces of material, but instead promote the joining of the two or more pieces joining areas by preparing the joining areas for welding.

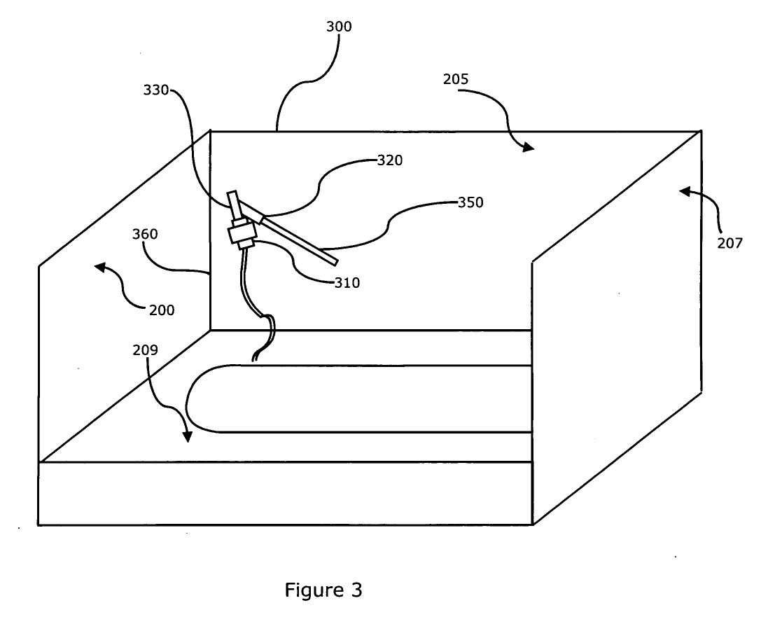

In a third step 130, the two or more pieces formed from similar material are joined together by the formation of a joint between them, wherein the joint may also provide a substantially water resistant and/or water tight seal. The manipulative processes employed by the current invention may promote or increase various characteristics, such as strength, durability, water resistance, and others as contemplated by skilled artisans, of the joint that is formed between the two or more pieces of similar material. The joining occurs via a welding of the two or more pieces using a third piece (“welding piece”) that is of similar material as the two or more pieces. The welding may occur using various techniques, tools, methodologies, and processes as are known by those skilled in the art. In the current embodiment, the welding occurs through the use of a fusion welder 310, as shown in FIG. 3, that employs an exemplary welding piece (rod 350), wherein the welding piece 350 is of the same material as that of the two or more pieces. Alternatively, the welding piece or rod 350 may be formed from one of the two or more pieces that are being joined together.

Designating the joining piece as a rod of material is not intended to limit is dimensional configurations as it is contemplated that any construction of the joining piece that promotes its capabilities to be used in the welding/bonding together of the multiple pieces that will form the substantially water resistant/tight structure may be used. It is further contemplated that the form and formation of the joining piece may be guided by its acceptance for use with a particular welding apparatus, thus, in the current embodiment of FIG. 3, it may be configured in any manner that allows it to fit in the fusion welder 310. Thus, the structural configuration of the welding piece (or rod) 350 may have different shapes and sizes, e.g., round, triangular, octagonal, flat strips, and different diameters, e.g., one type of rod is a 5/32″ round rod, a ¼″ triangular rod, 3/16″ flat strip rod, 5/32″ octagonal rod, ⅛″ round rod. It is further contemplated that the joining piece may include various aesthetic features that promote the overall appearance of the joined three pieces in their final form. For example, the joining piece may be matched in color to the two pieces of material 200 and 205 that are being joined or it may be of a different color. Alternatively, the joining piece may be constructed in the form of beads that are loaded onto the fusion welder 310.

As described above, the connection of the two or more pieces of material via a joint of the third piece is provided by the welding step 130. In the current embodiment, the two or more pieces such as 200 and 205 have their joining areas placed in a physical proximity to one another to allow the formation of a joint 360 between them via the welding process. The welding forms the joint 360 by melting the welding piece 350 and then applying the melted material of the welding piece 350 to the etched (and possibly heated) joining areas 210 of the two or more pieces of material 200 and 205. The melted material of the joining piece is allowed to cool and forms the joint that connects the two or more pieces of material together. It is contemplated that a physical manipulation of the physical proximity relationship between the two or more pieces that are being joined together may occur at any time during the welding process, particularly during the cooling of the melted material of the joining piece as it forms the joint.

The two or more pieces are physically joined together by the joining piece, thereby, creating a joint that forms a substantially water resistant/tight seal between the two or more pieces in a manner that may resist penetration by water or other liquids or substances. It is contemplated that the current invention may provide a joint that forms a seal of the two or more pieces in a manner that is substantially impenetrable by water or other liquids or substances.

It is contemplated that the tools, such as the welding apparatus (fusion welder) 310, may employ various devices, such as tip 330 shown in FIG. 3, to accomplish the welding process identified above in method 100. Different types of tips 330 may be utilized for applying the material of the welding piece 350 to the two or more pieces to be joined 200 and 205. For example, a hand held fusion welder or apparatus 310 with a 5/32″ tip and a 5/32″ triangular rod may be utilized. In some embodiments, a tacking tip may be used to form an initial joint that holds the two or more pieces together through the process. After the pieces are initially joined with the tacking tip, the welding piece (e.g., welding rod) may be heated to achieve the performance of the welding process described above. In addition to the tips, the welding apparatus, when a hand held welder 310, typically includes various other features, such as a blower unit that allows air to flow continuously and helps the welder maintain a constant temperature. The current invention contemplates the use of a welding apparatus (e.g., fusion welder) 310 that for one embodiment is electric, while in other embodiments it may be gas or employ other technologies. It is further contemplated that the welding apparatus may be capable of achieving various temperatures and temperature ranges that may vary between 300° F. and 500° F., preferably 325° F. to 335° F.

In alternative preferred embodiments, the present invention provides a kit and a system for installing a substantially water resistant/tight construct(s) in accordance with the method 100 described above. As shown in FIG. 3, the system may preferably include a welding apparatus 310, a welding piece(s) 350 (rod(s) or bead(s)) formed from the same material as the pieces to be joined, a first piece 200 (e.g., panel, wall, flat surface) formed of similar material as that used for the welding pieces, a second piece 205 formed of similar material as that used for the welding piece and first piece 200, a third piece 207 formed of a similar material as that used for the welding piece 350, first piece 200, and second piece 205, and a fourth piece 209 formed of similar material as that used for the welding piece 350, first piece 200, second piece 205, and third piece 207. In the current embodiment, the construct being installed is shown as and commonly referred to as a bathroom or bathtub surround. The material used to form the welding piece 350, first piece 200, second piece 205, third piece 207, and fourth piece 209 may preferably be an acrylic compound, as previously described. Thus, the first 200, second 205, and third pieces 207 may be acrylic walls and the fourth piece 209 may be the tub (tub liner or shower pan). It is contemplated that the system of the current invention may preferably be utilized to install a bathroom surround in an existing bathroom or installed in a new bathroom. It is further contemplated that a primary benefit that may be provided by the system of the current invention being installed in accordance with the method 100 of the current invention is that the bathroom surround may be substantially resistant and/or impenetrable by water, other liquids, and/or substances. It is still further contemplated that the system of the current invention may be utilized to install completely new bathroom surrounds in accordance with the method 100 of the current invention. Thus, where there may not have previously existed a construct configured for a surround, such as a bathroom, the current invention may be utilized for the construction of such a structure.

By way of example, the method of the present invention may be used in the installation of a bathroom surround system wherein the pieces that are joined to form the surround are constructed from acrylic compounds. A sheet of ABS, or other material suitable for bathroom use, may be placed over existing tile, sheetrock, and any other existing structure in the area where the new surround is going to be installed. After the pieces/materials to be joined are etched, the fusion welder is used to warm the materials. It is contemplated that the method of the current invention may include an additional step, of tacking the two or more pieces together through use of a tacking tip to form an initial joint. In the third step the rod or beads are utilized to weld the two pieces together. In one particular technique utilized to apply the joining material, the gun is turned upside down and the materials are welded from the bottom to the top in a slow motion that allows event distribution of the welding material. After the weld, of the joining piece, cools the installation may be substantially complete.

The current invention contemplates that the construct provided may use less than all of the pieces in a kit and/or system or employ method 100 in a abridged manner. For instance, an existing bathroom surround may include one or more panels that are desired to remain. Thus, in order to provide the benefit of the method of the current invention, an alternative method may be employed wherein a first step 110 includes selecting a welding piece 350 that is of a similar material of the existing panels. A second step 120 may include preparing joining areas of the panels through a sanding and/or etching process as described above. A third step 130 would include the welding of the panels together through use of the joining piece in a manner similar to that described above. Thus, the current method 100 provides the benefits of the current invention through use of a welding piece. As previously mentioned, the color and/or dimensional characteristics of the joining piece may vary to accommodate various needs. It is also contemplated that the current method may include the step of tacking the panels, similar to that described previously. Thus, a system and/or kit of the current invention may include a welding apparatus 310 and joining piece 350 (welding rod). It is further contemplated that a method of the current invention may provide for the selection of one or more pieces to be used in the construction of the construct to be formed and therefore, the system and kit may also include such varying numbers of pieces along with the welding apparatus and rod.

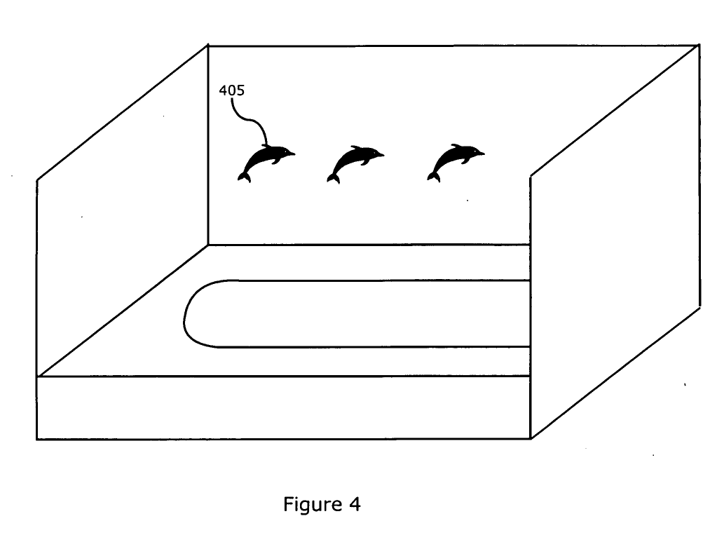

It is further contemplated by the current invention, that a secondary structure may be included in the system and kit of the current invention, and provide an additional step or steps to the method 100. The secondary structure may be of various forms and may connect with any one or more of the pieces of the current invention. In a preferred embodiment, the secondary structure includes an aesthetic display or ornamental design that may be formed in various manners into a piece of material. As shown in FIG. 4, the secondary structure may include, for example, a relief of a pod of dolphins 405. This secondary structure may be formed out of similar or different materials as that of the existing construct and/or joining piece, or other pieces that may or may not be included in the system and kit or used in method 100 of the current invention. It is further contemplated that the secondary structure may include various aesthetic features, such as the use of color, dimension, texture, and other aesthetic features as may be contemplated by skilled artisans, which may be integral with the material or applied to the material using well known techniques and methodologies.

The secondary structure may be of various designs, such as a sunrise, open field, sports symbol, icon, person, place, thing, animal, religious symbol and the like without departing from the scope and spirit of the present invention. The secondary structure may be connected with one or more of the pieces of the system and kit through the use of various techniques, tools, applicants, methodologies, and the like. For example, the secondary structure may be connected to a panel of a bathroom surround through the use of one or more adhesive materials that may be applied to either or both of the secondary structure and panel. Alternatively, the secondary structure may be connected to one or more panels through use of a welding process, which may be similar to or different from the welding process described above. It is contemplated that the connection between the secondary structure and panel may be accomplished through use of a single application or the combination of multiple techniques and methodologies, such as the use of an adhesive and a welding process.

The configuration of the secondary structure may further vary according to whether or not it spans a joint/connection between two or more pieces/panels of a construct. For example, overall dimensions, such as length, width, height, depth may remain similar for a first and second secondary structure, along with a similar aesthetic design being displayed. However, where the first display is constructed generally in along a single plane or in a planar fashion, the second secondary structure may include one or multiple planes set at various angles to one another. This may allow the secondary structure to be connected and affix generally along the surface of two panels whose planar surfaces are set at right angles to one another. This may be advantageous where the construct to which the secondary structure is to be affixed does not include a planar surface large enough to encompass the secondary structure's dimensional configuration.

It is further contemplated that the welding step of the method 100, of the current invention, may further include the joining of the plumbing elements of a bathroom surround. For example, using the welding techniques and methodologies of the current invention may allow the joining of the drain of the shower pan, or acrylic tubs, and may promote a decrease in the use or the need for gaskets, which may become faulty and leak in the future. In the current example, an acrylic shower pan may be installed and a two inch pipe may be welded to a drain hole with a 2 1/16″ diameter. In another embodiment of the present invention, a drain pipe is installed so as to run along the bottom of the shower pan and be welded to the drain hole. The method of the present invention may also be utilized in acrylic sinks and vanities. In yet a separate embodiment of the present invention, the method may be utilized to weld portions of exterior windows, siding, and exterior trim.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for welding acrylic materials, comprising:
selecting a first piece of acrylic material,
selecting a second piece of said acrylic material,
selecting a welding piece of said acrylic material,
utilizing said welding piece to weld said first piece and second piece of acrylic material together.

2. The method of claim 1, wherein said acrylic material is acrylo-lamitral butadiene/durable rubber (ABS/DR).

3. The method of claim 1, wherein said acrylic material is selected from the group consisting of cellulose acetate (CA), cellulose acetate butolrate (CAB), poly-vinyl chloride (PVC), high density polyethylene (HDPE), high molecular weight polyethylene (HMW), ultrahigh molecular weight polyethylene (UHMVV), low density polyethylene (LDPE), linear low density polyethylene (LLDPE), ultra low density polyethylene (ULLDPE), medium density polyethylene (MDPE), high polypropylene (HPP), copolypropylene (CPP), thermo plastic urethane (TPU), polyethylene tirophylilate gluco-modified (PETG), acrylo-lamitral butadiene stylene (ABS), high impact poly styrene (HIPS), flexible PVC (FPVC), and acrylo-lamitral butadiene/durable rubber (ABS/DR).

4. The method of claim 1, wherein a first welding area in said first piece and a second welding area in said second piece are prepared for welding by at least one of chemical or mechanical process.

5. The method of claim 4, wherein said first piece and second piece are welded with a fusion apparatus that melts said welding piece and heats said first welding area and said second welding area.

6. The method of claim 1, wherein said welding piece is selected from the group consisting of a rod and welding beads.

7. The method of claim 1, wherein said welding piece is applied through a fusion welder tip.

8. The method of claim 5, wherein said fusion apparatus heats the welding piece to a temperature between 300° F. and 500° F.

9. The method of claim 8, wherein said fusion apparatus heats the welding piece to a temperature between 325° F. to 335° F.

10. A kit for welding acrylic materials, comprising:
a first piece of acrylic material,
a second piece of said acrylic material,
a welding piece of said acrylic material, and instructions to weld said first piece and second piece by utilizing said welding piece.

11. The kit of claim 10, further comprising:
a welding apparatus.

12. The kit of claim 10, wherein said acrylic material is acrylo-lamitral butadiene/durable rubber (ABS/DR).
The kit of claim 10, wherein said acrylic material is selected from the group consisting of cellulose acetate (CA), cellulose acetate butolrate (CAB), poly-vinyl chloride (PVC), high density polyethylene (HDPE), high molecular weight polyethylene (HMW), ultrahigh molecular weight polyethylene (UHMVV), low density polyethylene (LDPE), linear low density polyethylene (LLDPE), ultra low density polyethylene (ULLDPE), medium density polyethylene (MDPE), high polypropylene (HPP), copolypropylene (CPP), thermo plastic urethane (TPU), polyethylene tirophylilate gluco-modified (PETG), acrylo-lamitral butadiene stylene (ABS), high impact poly styrene (HIPS), flexible PVC (FPVC), and acrylo-lamitral butadiene/durable rubber (ABS/DR).

13. A method for welding an ornamental design to a piece of acrylic material, comprising:
selecting an ornamental design constructed from said acrylic material;
selecting a welding piece of said acrylic material,
utilizing said welding piece to weld said ornamental design to said piece of acrylic material.

14. The method of claim 13, wherein said acrylic material is acrylo-lamitral butadiene/durable rubber (ABS/DR).

15. The method of claim 13, wherein said acrylic material is selected from the group consisting of cellulose acetate (CA), cellulose acetate butolrate (CAB), poly-vinyl chloride (PVC), high density polyethylene (HDPE), high molecular weight polyethylene (HMW), ultrahigh molecular weight polyethylene (UHMVV), low density polyethylene (LDPE), linear low density polyethylene (LLDPE), ultra low density polyethylene (ULLDPE), medium density polyethylene (MDPE), high polypropylene (HPP), copolypropylene (CPP), thermo plastic urethane (TPU), polyethylene tirophylilate gluco-modified (PETG), acrylo-lamitral butadiene stylene (ABS), high impact poly styrene (HIPS), flexible PVC (FPVC), and acrylo-lamitral butadiene/durable rubber (ABS/DR).

16. The method of claim 13, wherein a first welding area in said piece of acrylic material and a second welding area in said ornamental design are prepared for welding by at least one of a chemical or a mechanical process.

17. The method of claim 16, wherein piece or acrylic material and said ornamental design are welded with a fusion apparatus that melts said welding piece and heats said first welding area and said second welding area.

18. The method of claim 13, wherein said welding piece is selected from the group consisting of a rod and a welding bead.

19. The method of claim 13, wherein said welding piece is applied through a fusion welder tip.
